(19) United States
(12) Patent Application Publication
(10) Pub. No.: US 2015/0131034 A1
(43) Pub. Date: May 14, 2015

(54) APPARATUS AND METHOD FOR MANUFACTURING MICRO LENS ARRAY, AND MICRO LENS ARRAY MANUFACTURED USING THE SAME

(71) Applicant: KOREA INSTITUTE OF SCIENCE AND TECHNOLOGY, Seoul (KR)

(72) Inventors: Il-Joo CHO, Seoul (KR); Eui Sung YOON, Seoul (KR); Hyunjoo Jenny LEE, Seoul (KR)

(73) Assignee: KOREA INSTITUTE OF SCIENCE AND TECHNOLOGY, Seoul (KR)

(21) Appl. No.: 14/314,202

(22) Filed: Jun. 25, 2014

(30) Foreign Application Priority Data
Nov. 13, 2013 (KR) 10-2013-0137435

(51) Int. Cl. G02F 1/1333; G02B 27/22

(52) U.S. Cl. CPC G02F 1/133377; G02B 27/22
USPC 349/95; 425/175; 264/2.5; 216/26

(57) ABSTRACT

As an apparatus for manufacturing a micro lens array includes a first substrate having a plurality of cavities formed at locations corresponding to locations of the plurality of micro lenses, and a second substrate having a lower softening point than the first substrate and bonded on the first substrate to close the plurality of cavities, wherein a portion of the second substrate located on the cavities swells convexly by air trapped in the cavities expanding its volume in response to a temperature above the softening point of the second substrate being applied, to form domes corresponding to a shape of the micro lenses, and the micro lens array is cast using the second substrate having the formed domes as a mold.

### CROSS-REFERENCE TO RELATED APPLICATION

This application claims priority to Korean Patent Application No. 10-2013-0137435, filed on Nov. 13, 2013, and all the benefits accruing therefrom under 35 U.S.C. §119, the contents of which in its entirety are herein incorporated by reference.

### BACKGROUND

1. Field

The present disclosure relates to an apparatus and method for manufacturing a micro lens array and a micro lens array manufactured using the same, and more particularly, to an apparatus and method for manufacturing a micro lens array by use of a mold made using volume expansion of air trapped in a closed space in response to an increase in temperature.

2. Description of the Related Art

Micro lens arrays (MLAs) are a component basically needed in the application fields of micro-optics such as optical communication, interconnection, direct optical imaging, and a lab-on-a-chip.

FIG. 1 is a perspective view illustrating a micro lens array 1 according to an example of a related art.

The micro lens array 1 generally includes a square plate-shaped base substrate 2, and a plurality of micro lenses 3 protruding in a shape of a hemisphere beyond the base substrate 2.

The micro lens 3 has a sag height (h) from a top of the base substrate 2 and a diameter denoting a diagonal length of a contact region with the base substrate 2.

A micro lens array used in an imaging device such as a charge coupled device (CCD) image sensor, a two-dimensional (2D) vertical cavity surface emitting laser (VCSEL), and a three-dimensional (3D) liquid crystal display (LCD), is required to have a high fill factor and a high numerical aperture (NA).

A fill factor represents a ratio of an area occupied by micro lenses to a total area of a base substrate, and is a parameter indicating how dense micro lenses are arranged in a micro lens array.

A numerical aperture represents a number of micro lenses formed on a base substrate.

A high numerical aperture allows high resolution imaging by improving light collection efficiency of a micro lens array, and a high fill ratio improves a signal-to-noise ratio by reducing an amount of light not focused in a micro lens array.

Additionally, it is very important for a micro lens array to have a wide range of dimensions from a few micrometers (μm) to a few hundreds of micrometers without sacrificing an optical quality.

In the application fields of micro lens arrays known in recent days such as a bioassay and a 3D LCD panel, micro lenses are required to have not only a high numerical aperture and a high fill factor but also a large dimension of a few hundreds of micrometers.

In the manufacture of a micro lens array having a high numerical aperture, dimension adjustment of the micro lens array is a problem that still needs to be solved.

According to a related art, for example, a micro lens array having a large diameter of 150 to 15000 μm is implemented by a LIGA process (lithography, electroplating, molding) or a photoresist thermal flow process, but numerical apertures of micro lens arrays manufactured by these methods are just 0.047 and 0.19 per unit area, respectively.

Methods of manufacturing a micro lens array having a high numerical aperture of 0.4 to 0.5 per unit area by a photoresist thermal flow process, laser direct writing, elastic deformation of an ultraviolet (UV) curable composition, and an inkjet printing method, have been reported.

FIG. 2 is a diagram illustrating a method for manufacturing a micro lens array using a photoresist thermal flow process according to an example of a related art.

Referring to FIG. 2, first, a photoresist 104 is coated onto a substrate 102 (FIG. 2(a) and FIG. 2(b)), a portion of the photoresist is melted such that a plurality of split photoresist pieces 106 remains on the substrate 102 (FIG. 2(c)), and heat is applied to adhere the remaining photoresist to a base substrate 103 (thermal reflow). In this process, the photoresist is melted and forms a hemisphere by cohesion of liquid (FIG. 2(d)).

Subsequently, a material is deposited onto the substrate 102 to form a mold 110 (FIG. 2(e) and FIG. 2(f)), and a melted material for a micro lens array is poured into the mold 110 and cured to form a micro lens array 120.

On the other hand, an inkjet printing method omits the steps of FIG. 2(a) through FIG. 2(c) in the above method, and puts drops of a liquid material on a substrate to form a hemispherical shape on the substrate by cohesion of liquid in the same way as FIG. 2(d), followed by curing. The subsequent process is substantially same as the above method.

However, diameters of micro lens arrays manufactured by these methods are limited to a few tens of μm (5-76.4 μm) to maintain a high numerical aperture.

Also, because these methods use a method of curing a liquid material on a base substrate, a shape of a resulting micro lens is limited to a circular shape.

Further, because a liquid material drop should maintain its hemispherical shape by cohesion, there is a constraint that a sag height is a function greatly dependent on a diameter. Due to various constraints including effects of gravity and the like, a sag height of a micro lens formed according to a related art is remarkably smaller than its diameter (around 1:10).

To solve these problems, laser direct writing forms a shape corresponding to micro lenses in a mold for a micro lens array through laser etching, but this mechanical etching method degrades surface roughness characteristics of a resulting micro lens array due to an irregular surface of the mold, resulting in a reduction in optical effects.

### SUMMARY

The present disclosure is designed to solve the above problem of the related art, and therefore, the present disclosure is directed to providing an apparatus and method for manufacturing a micro lens array in which a diameter and a sag height of resulting micro lenses can be adjusted freely, and that has excellent optical effects due to a smooth surface.

To achieve the object, according to one aspect, there is provided an apparatus for manufacturing a micro lens array, the micro lens array including a base substrate and a plurality of micro lenses protruding beyond the base substrate, the apparatus including a first substrate having a plurality of cavities formed at locations corresponding to locations of the plurality of micro lenses, and a second substrate having a lower softening point than the first substrate and bonded on the first substrate to close the plurality of cavities, wherein a portion of the second substrate located on the cavities swells convexly by air trapped in the cavities expanding its volume in response to a temperature above the softening point of the second substrate being applied, to form domes corresponding to a shape of the micro lenses, and the micro lens array is cast using the second substrate having the formed domes as a mold.

According to an embodiment, a height of the domes being formed may be adjustable by adjusting the temperature or a depth of the cavities.

Also, the apparatus for manufacturing the micro lens array may further include a pressure chamber to adjust a pressure around the first substrate and the second substrate bonded together, and a height of the domes being formed may be adjustable by adjusting the pressure.

The plurality of cavities may be classified into a plurality of groups including at least one cavity, and when the first substrate is viewed from top, the cavities may differ in cross sectional shape or diameter for each group.

The diameter may be from 50 micrometers to 1 millimeter.

Also, the plurality of cavities may be formed to have different depths for each group.

Also, the cavities may be formed to have different distances between adjacent two cavities for each group.

According to an embodiment, the first substrate may be formed from silicon, and the second substrate may be formed from glass.

According to another embodiment, there is provided a method for manufacturing a micro lens array, the micro lens array including a base substrate and a plurality of micro lenses protruding beyond the base substrate, the method including forming a first substrate having a plurality of cavities formed at locations corresponding to locations of the plurality of micro lenses, forming a second substrate having a lower softening point than the first substrate, bonding the second substrate onto the first substrate to close the plurality of cavities, applying a temperature above the softening point of the second substrate to the first substrate and the second substrate bonded together to form domes corresponding to a shape of the micro lenses in response to convexly swelling of a portion of the second substrate located on the cavities by volume expansion of air trapped in the cavities, forming a mold by removing at least a portion of the first substrate such that openings formed on a back surface of the domes are exposed outside, and forming the micro lens array by pouring a melted material for the micro lens array into the mold and curing.

According to an embodiment, the method for manufacturing the micro lens array may further include adjusting a height of the domes being formed, by adjusting the temperature and/or a pressure applied to the first substrate and the second substrate bonded together.

Also, the first substrate and the second substrate may be bonded by anodic bonding.

Also, the method for manufacturing the micro lens array may further include coating a nitride layer on a back surface of the first substrate along an edge part excluding as much as an area of the base substrate from a center, the forming of the mold by removing at least a portion of the first substrate may be performed by a wet anisotropic etching process, and the nitride layer may be a mask layer that allows a nitride coating part to prevent the first substrate from being etched by the etching process.

Also, the cavities may be formed by deep reactive-ion etching (DRIE).

According to another aspect, there is provided a micro lens array manufactured by the apparatus for manufacturing the micro lens array.

### BRIEF DESCRIPTION OF THE DRAWINGS

FIG. 1 is a perspective view illustrating a micro lens array according to an example of a related art.

FIG. 2 is a diagram illustrating a method for manufacturing a micro lens array using a photoresist thermal flow process according to an example of a related art.

FIGS. 3 and 4 are diagrams illustrating an apparatus and method for manufacturing a micro lens array according to an exemplary embodiment.

FIG. 5 is a diagram illustrating adjustment of a sag height of a dome by temperature adjustment in an apparatus for manufacturing a micro lens array according to an exemplary embodiment.

FIG. 6 is a diagram illustrating adjustment of a sag height of a dome by pressure adjustment in an apparatus for manufacturing a micro lens array according to an exemplary embodiment.

FIG. 7 is a graph illustrating a relationship between a diameter and a sag height of a micro lens array.

FIG. 8 is a diagram illustrating a first substrate in which cavities of various fill factors and various shapes are formed simultaneously according to an exemplary embodiment.

FIG. 9 is an enlarged diagram illustrating a lens array formed using the first substrate of FIG. 8.

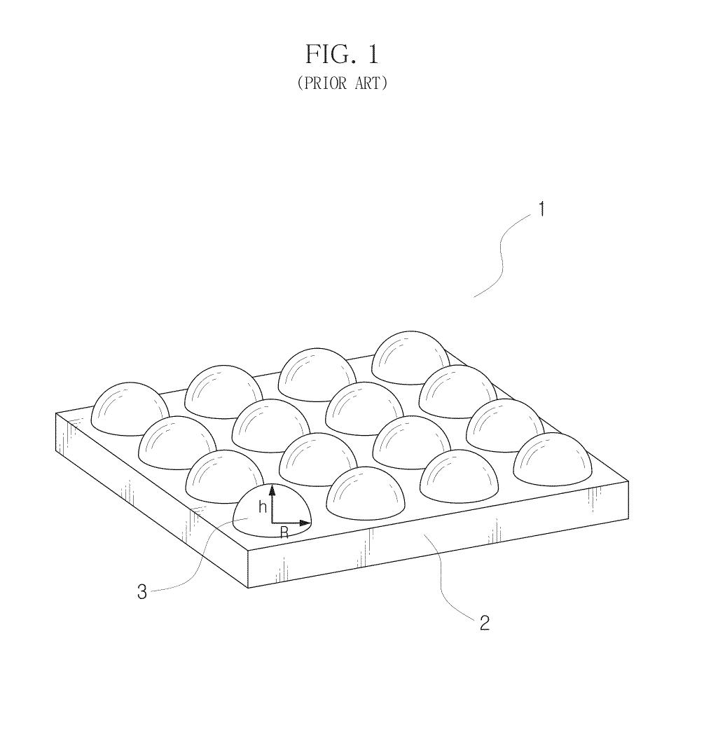

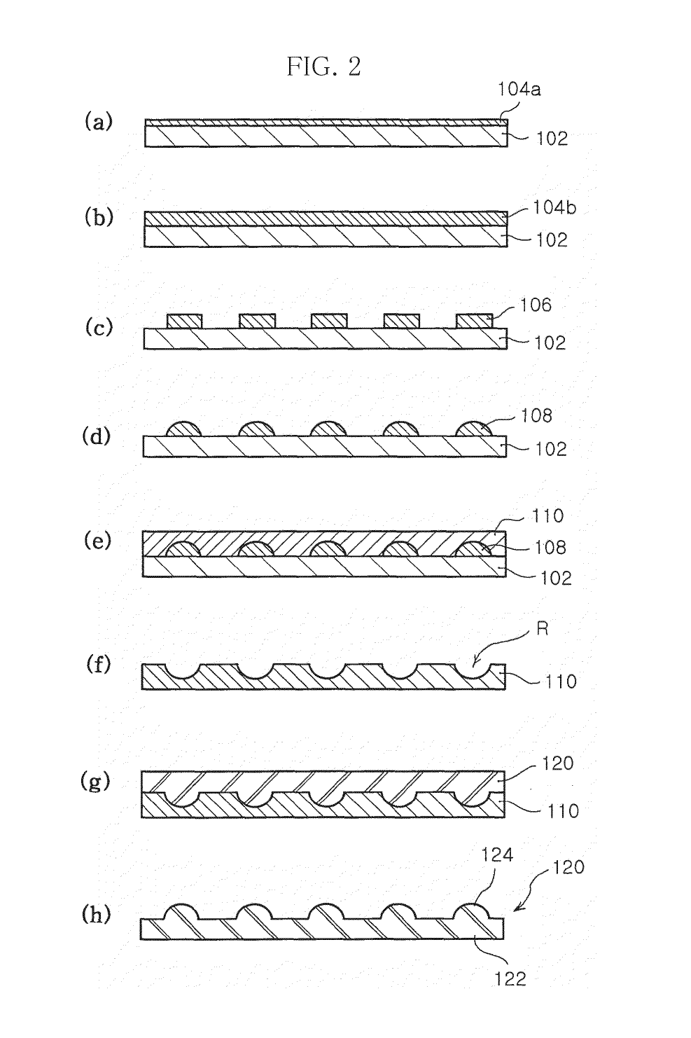

### DETAILED DESCRIPTION

Hereinafter, preferred embodiments are described with reference to the accompanying drawings. While the present disclosure is described with reference to exemplary embodiments shown in the drawings, it is intended that the embodiments are merely described as a mode for carrying out this disclosure and the scope of the present disclosure and its essential elements and functions are not limited by such embodiments.

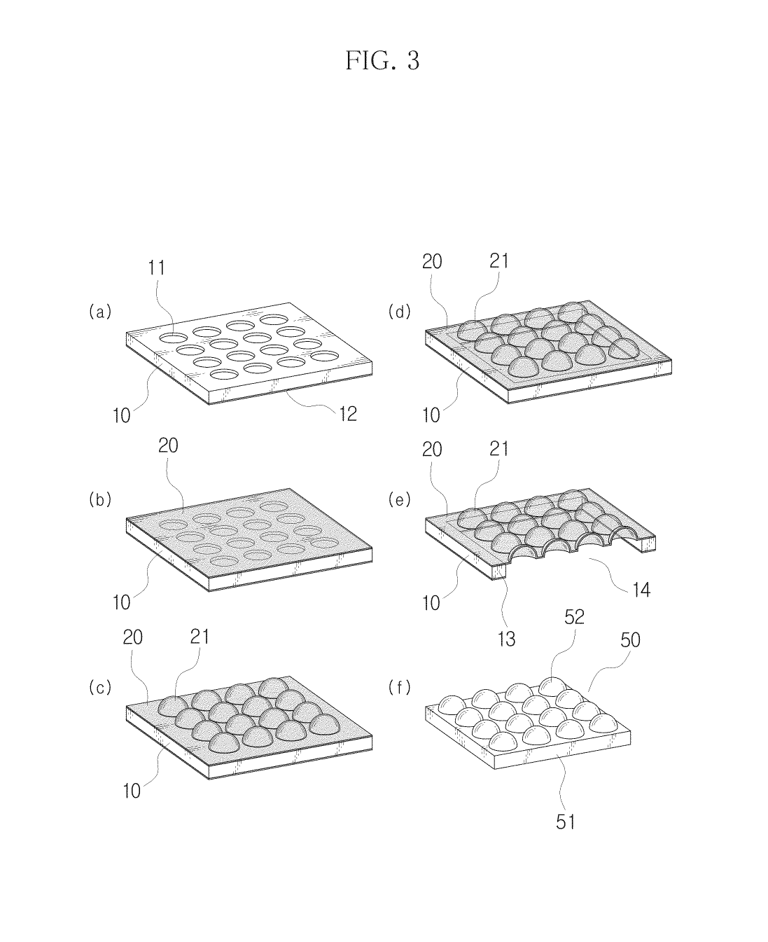

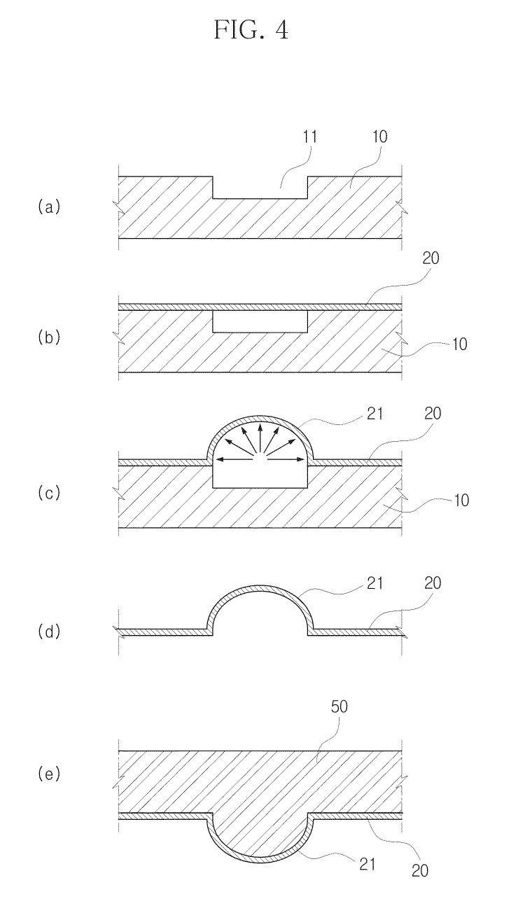

FIGS. 3 and 4 are diagrams illustrating an apparatus and method for manufacturing a micro lens array (hereinafter abbreviated to a “lens array”) according to an exemplary embodiment.

As shown in FIG. 3(f), the apparatus and method for manufacturing the lens array according to this embodiment is configured to manufacture a lens array 50 including a square plate-shaped base substrate 51 and a plurality of micro lenses 52 protruding in a shape of a hemisphere beyond the base substrate 51.

As shown in FIGS. 3 and 4, the apparatus for manufacturing the lens array includes a first substrate 10 having a plurality of cavities 11 formed at locations corresponding to locations of the plurality of micro lenses 51, and a second substrate 20 bonded on the first substrate 10 to close the plurality of cavities 11.

The first substrate 10 is a substrate made from silicon of which both surfaces are polished.

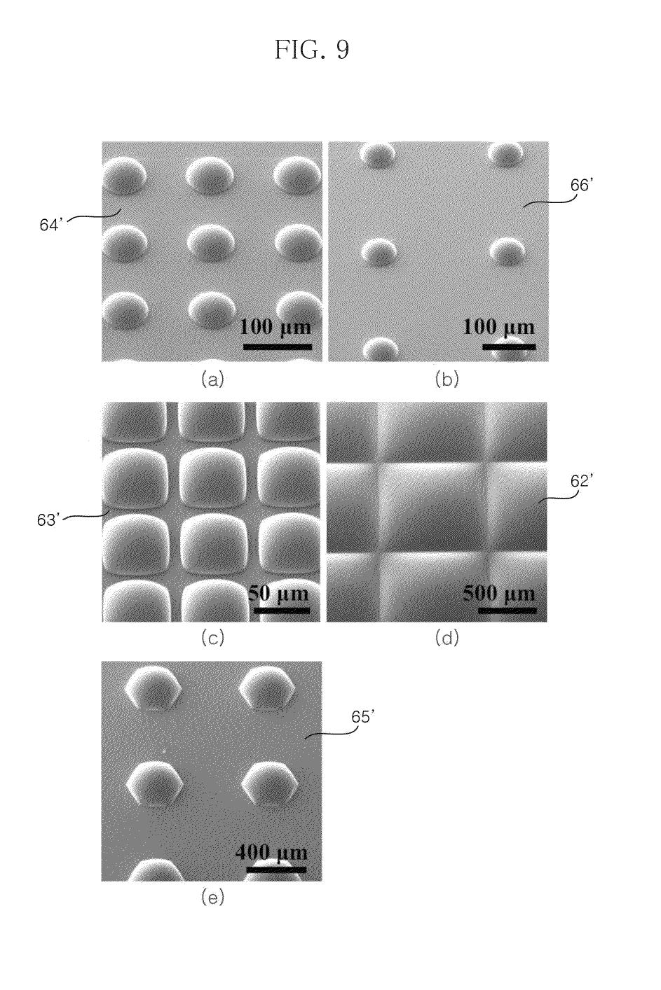

The plurality of cavities 11 having a circular cross section are arranged in rows and columns in an upper surface of the first substrate 10. Although this embodiment shows and describes a cross sectional shape of the cavity 11 as a circular shape, the cross sectional shape is not limited thereto. As shown in FIG. 9, the cavity 11 formed in the first substrate 10 may have various polygonal shapes including a square shape, a hexagonal shape, and the like.

The cavity 11 according to this embodiment is formed by deep reactive-ion etching (DRIE). As the cavity 11 is formed by DRIE, a depth and a diameter of the cavity 11 may be adjusted relatively freely.

According to this embodiment, the diameter of the cavity 11 is in a range from 50 micrometers to 1 millimeter.

A nitride layer 12 is coated in a shape of “ [symbol] ” on a back surface of the first substrate 10 along an edge part except a center part below a region in which the cavities 11 are formed. An area of the center part uncoated with the nitride layer is equivalent to an area of a substrate 51 of a lens array 50 as a final product.

The second substrate 20 is made from borosilicate glass. A softening point of the second glass substrate 20 is lower than a softening point of the first silicon substrate 10.

It should be understood that the materials for the first substrate 10 and the second substrate 20 are not limited to silicon and glass, and any material having a relationship of M1>M2>ML among softening points of the material (M1) for the first substrate 10, the material (M2) for the second substrate 20, and the material (ML) for the lens array may be used.

As shown in FIGS. 3 and 4, the second substrate 20 is put on the formed first substrate 10 and bonded together (FIG. 3(b) and FIG. 4(b)). According to this embodiment, the first substrate 10 and the second substrate 20 are strongly bonded to one another in an atmospheric pressure condition by anodic bonding that is a voltage-assisted bonding method.

As the first substrate 10 and the second substrate 20 are bonded, the cavities 11 of the first substrate 10 are closed and sealed by the second substrate 20.

According to this embodiment, an initial thickness of the second substrate 20 laid on the first substrate 10 is 500 μm, and a reduced thickness of the second substrate 20 polished by a subsequent chemical mechanical polishing (CMP) process is about 30 μm.

The first substrate 10 and the second substrate 20 bonded together are placed in a furnace (not shown) of 700° C., and heated for 30 minutes under an atmospheric pressure.

As the temperature of 700° C. above the softening temperature of the second glass substrate 20 is applied, air trapped in the cavities 11 expands its volume, and the softened and melted second substrate 20 at the temperature above the softening temperature swells convexly in a uniform hemispherical shape by volume expansion of the air to form domes 21 (FIG. 3(c) and FIG. 4(c)). The domes 21 are a part to be a mold for the micro lenses 51, and have a shape corresponding to the shape of the micro lenses 51.

Subsequently, a 30% potassium hydroxide (KOH) wet anisotropic etching process is performed at temperature of 85° C. for 5 hours and 10 minutes.

The 30% potassium hydroxide (KOH) wet anisotropic etching process is a process having a very high etch selectivity to glass, and with this etching process, only the first silicon substrate 10 is selectively removed while not damaging the second glass substrate 20 (FIG. 3(d) and FIG. 4(d)).

In this process, the nitride layer 12 coated on the back surface of the first substrate 10 acts as a sort of mask layer to prevent etching, hence a portion of the first substrate 10 below the nitride layer is not etched.

Accordingly, as shown in the partial cross-sectional view of FIG. 3(e), a center part 14 of the first substrate 10 as much as an area of the base substrate 51 is removed, so that openings formed at a back surface of the domes 21 are exposed outside, whereas a part 13 of the first substrate 10 running along edges of a back surface of the second substrate 20 remains.

The second substrate 20 having the formed domes 21 and the remaining part 13 of the first substrate 10 become a mold for casting the lens array 50.

Subsequently, vapor phase silane is coated on a surface of the formed mold.

A melted liquid-type polydimethylsiloxane (PDMS) solution is poured into the mold (FIG. 4(e)), and cured in a vacuum oven (not shown) of 85° C. for 1 hour to remove bubbles from inside.

The cured PDMS is detached from the mold, and the PDMS lens array 50 is completed (FIG. 3(f))

A sag height (h) of the micro lens 52 protruding from the lens array 50 is an important parameter that directly affects optical properties such as a curvature, a focal length, and a numerical aperture of the lens.

According to this embodiment, because the domes 21 as the mold for the micro lenses 52 is formed using a so-call “glass blowing” method, the sag height (h) of the lens may be adjusted independently from its radius by properly adjusting a parameter of the glass blowing method.

The sag height (h) of the lens may be calculated by a relation such as [Equation 1] and [Equation 2].

$$\begin{matrix}h = \frac{{[ ( 3 {V}_{g} + \sqrt{{r}_{o}^{6} {π}^{2} + 9 V {g}^{2}} ) {π}^{2} ]}^{2 / 3} - {r}_{o}^{2} {π}^{2}}{{π [ ( 3 {V}_{g} + \sqrt{{r}_{o}^{6} {π}^{2} + 9 V {g}^{2}} ) {π}^{2} ]}^{1 / 3}} & [ Equation 1 ] \\ {V}_{g} = {h}_{o} π {r}_{o}^{2} ( \frac{{T}_{g}}{{T}_{o}} \frac{{P}_{o}}{{P}_{g}} - 1 ) & [ Equation 2 ]\end{matrix}$$

Here, hₒ denotes a depth of the cavity 11, rₒ denotes a radius of the cavity 11, and P_{g} and T_{g} denote a pressure and a temperature around the first substrate and the second substrate during formation of the domes 21, respectively.

V_{g} denotes a volume of a space in which the domes 21 and the cavities 11 are formed, Tₒ denotes a temperature when the first substrate and the second substrate are anodically bonded, and Pₒ denotes an initial pressure of the closed cavity 11.

As seen from the above equations, according to this embodiment, the sag height (h) of the micro lens 52 (that is, a sag height of the dome 21) may be properly adjusted by adjusting the depth (hₒ) of the cavity, and/or the pressure and/or temperature around the first substrate and the second substrate during the glass blowing process.

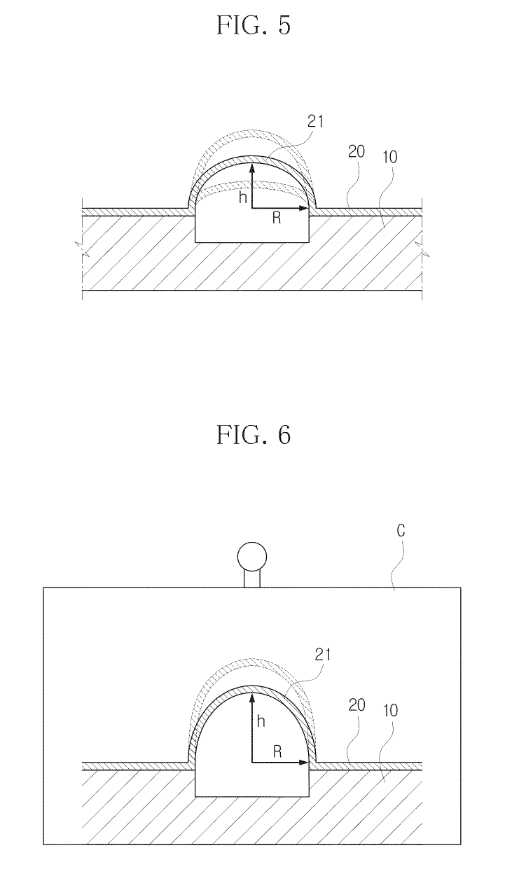

FIG. 5 illustrates adjustment of the sag height of the dome 21 by adjusting temperature of a furnace in which the bonded first and second substrates 10 and 20 are placed.

As shown in FIG. 5, in response to adjustment of the temperature of the furnace, the sag height (h) of the dome 21 changes while a radius (R) of the dome 21 (that is, a radius of the lens) remains unchanged.

In FIG. 6, after the bonded first and second substrates 10 and 20 are placed in a pressure chamber (C), adjustment of the sag height of the dome 21 by adjusting pressure of the pressure chamber (C) is illustrated.

As shown in FIG. 6, the dome 21 may be formed with a higher sag height by lowering pressure of an atmosphere in which the first and second substrates 10 and 20 are placed.

According to this embodiment, a desired optical specification may be obtained by adjusting the sag height independently from the radius of the lens by properly selecting the depth of the cavity 11 and the blowing condition (temperature and pressure) through the “glass blowing” process.

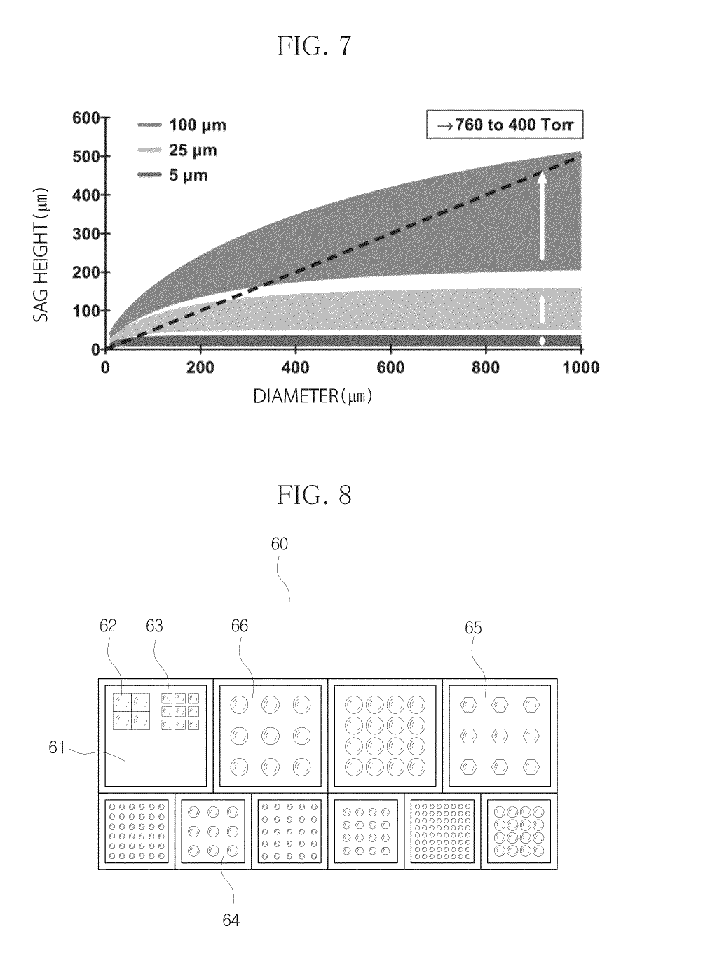

FIG. 7 is a graph illustrating that a lens may have a variously adjustable sag height while having a same diameter.

For example, at cavity depths of 5 μm, 25 μm, and 100 μm, when a blowing temperature is fixed at 700° C. and a pressure changes from 760 to 400 Torr, it can be seen that a sag height (h) gradually increases as shown in FIG. 7.

Meanwhile, a numerical aperture (NA) is an important parameter of optical properties to a lens array. In a plano-convex lens, a maximum numerical aperture (NAₘₐₓ) is determined by a radius (rₒ) and a focal length (f) of a micro lens, and may be also determined by a refractive index (n) of a constituent material of the lens array.

In a plano-convex lens, a maximum numerical aperture (NAₘₐₓ) is represented by the following [Equation 3].

$${NA}_{m a x} = \frac{{r}_{o}}{\sqrt{{r}_{o}^{2} + {f}^{2}}} = \frac{n - 1}{\sqrt{{n}^{2} - 2 n + 2}} \qquad [ Equation 3 ]$$

It is known that in a plano-convex lens, a maximum numerical aperture (NAₘₐₓ) is obtained when a sag height (h) is equal to a radius (rₒ) of a micro lens.

A maximum numerical aperture of a lens array may increase by forming a lens array using a material having a high refractive index during a replication process such as a UV curable polymer. However, in case a type of a material for a lens array is determined based on a purpose of use, it needs to properly adjust a sag height (h) of a lens.

As described in the foregoing, according to this embodiment, because a sag height of a lens is adjustable, a lens array may have a maximum numerical aperture by adjusting a sag height of a lens to be equal to a radius of the lens.

According to this embodiment, a maximum numerical aperture that can be obtained from a hemispherical PDMS micro lens (n=1.4) is 0.37 per unit area.

Meanwhile, according to this embodiment, because the cavities 11 are formed in the first substrate 10 using DRIE, not only a depth of the cavities 11 but also a cross sectional shape and a diameter of the cavities 11 and a number of the cavities 11 per unit area may be adjusted freely. That is, this implies that a fill factor and a numerical aperture of the lens array 50 may be adjusted relatively freely.

The fill factor of the lens array 50 is determined by an edge-to-edge distance and a center-to-center distance (that is, a pitch) between adjacent micro lenses 52 and a lens shape.

As a result of measurement, using the method according to this embodiment, in the case of a hemispherical micro lens, it can be seen that the hemispherical micro lens may be formed to have various fill factors in a very wide range from 2.2% to 75.5%. In the case of a hemispherical lens, a theoretical maximum fill factor is 78.5%.

Also, the micro lens may have a convex shape swollen from a basic shape of a polygonal shape, for example, a square shape, a hexagonal shape, and the like, by adjusting a cross sectional shape of the cavity 11 based on a purpose of use of the lens array and the like. In the case of a lens array including a square-shaped micro lens having a width of 1 mm, it was found that a maximum fill factor of 96.1% may be obtained.

Such a high fill factor may be achieved by a high bonding strength between silicon and glass.

Meanwhile, according to this embodiment, because the cavities 11 are formed in the first substrate 10 using DRIE, it is also very easy to form micro lenses having various fill factors, sag heights, diameters, and numerical apertures simultaneously on one base substrate.

FIG. 8 illustrates a first substrate 60 in which cavities of various fill factors and various shapes are formed simultaneously. FIG. 9 is a partially enlarged diagram illustrating a lens array formed using the first substrate 60 of FIG. 8.

As shown in FIG. 8, a plurality of cavities formed in the first substrate 60 may be grouped into a plurality of groups (61 through 66). At least one cavity is included in each group.

According to this embodiment, the cavities differ, for each group, in a cross sectional shape and/or a diameter, a depth, and a distance between adjacent two cavities.

According to this construction, as shown in FIG. 9, micro lenses having various shapes, fill factors, and diameters may be formed on one base substrate, and a lens array usable in various application fields may be manufactured.

In FIG. 9, a reference numeral indicated by a prime symbol (′) indicates that a corresponding lens is formed in an identical reference numeral group of FIG. 9.

According to this embodiment, a mold for forming a lens array is not formed by a mechanical etching method such as laser etching and the like, but is formed by uniform expansion of air, hence, a surface roughness of a resulting lens array is excellent. The surface roughness of the lens array is a parameter that directly affects optical properties.

According to this embodiment, as a result of measuring a surface roughness of a square measurement area of 3 μm×3 μm using an atomic force microscopy, approximately 5.0 nm was measured. As a result of measuring a scattering rate of the lens array having the surface roughness of approximately 5.0 nm using a total integrated scattering (TIS) method, the scattering rate was measured in a range of about 0.8 to about 2.6%. This numerical value is at an applicable level to a majority of optical products.

Also, it was found experimentally that the formed lens array has excellent optical confinement.

According to this embodiment, a mold is formed through a so-called “glass blowing” process after cavities are uniformly formed in a first substrate, and accordingly, very uniform and various lens arrays with excellent optical parameters may be manufactured in comparison to a related art.

According to this embodiment, the apparatus and method for manufacturing the lens array may be very effectively used in manufacturing a micro lens array with a high numerical aperture and a high fill factor in which micro lenses have a small diameter from 50 micrometers to 1 millimeter that is difficult to manufacture by etching directly.

What is claimed is:

1. An apparatus for manufacturing a micro lens array, the micro lens array comprising a base substrate and a plurality of micro lenses protruding beyond the base substrate, the apparatus comprising:
a first substrate having a plurality of cavities formed at locations corresponding to locations of the plurality of micro lenses; and
a second substrate having a lower softening point than the first substrate and bonded on the first substrate to close the plurality of cavities,
wherein a portion of the second substrate located on the cavities swells convexly by air trapped in the cavities expanding its volume in response to a temperature above the softening point of the second substrate being applied, to form domes corresponding to a shape of the micro lenses, and
the micro lens array is cast using the second substrate having the formed domes as a mold.

2. The apparatus for manufacturing the micro lens array according to claim 1, wherein a height of the domes being formed is adjustable by adjusting the temperature.

3. The apparatus for manufacturing the micro lens array according to claim 1, wherein a height of the domes being formed is adjustable by adjusting a depth of the cavities.

4. The apparatus for manufacturing the micro lens array according to claim 1, further comprising:
a pressure chamber to adjust a pressure around the first substrate and the second substrate bonded together,
wherein a height of the domes being formed is adjustable by adjusting the pressure.

5. The apparatus for manufacturing the micro lens array according to claim 1, wherein the plurality of cavities are classified into a plurality of groups including at least one cavity, and when the first substrate is viewed from top, the cavities differ in cross sectional shape or diameter for each group.

6. The apparatus for manufacturing the micro lens array according to claim 5, wherein the diameter is from 50 micrometers to 1 millimeter.

7. The apparatus for manufacturing the micro lens array according to claim 1, wherein the plurality of cavities are classified into a plurality of groups including at least one cavity, and the cavities differ in depth for each group.

8. The apparatus for manufacturing the micro lens array according to claim 1, wherein the plurality of cavities are classified into a plurality of groups including at least one cavity, and the cavities differ in distance between adjacent two cavities for each group.

9. The apparatus for manufacturing the micro lens array according to claim 1, wherein the first substrate is formed from silicon, and the second substrate is formed from glass.

10. A method for manufacturing a micro lens array, the micro lens array comprising a base substrate and a plurality of micro lenses protruding beyond the base substrate, the method comprising:
forming a first substrate having a plurality of cavities formed at locations corresponding to locations of the plurality of micro lenses;
forming a second substrate having a lower softening point than the first substrate;
bonding the second substrate onto the first substrate to close the plurality of cavities;
applying a temperature above the softening point of the second substrate to the first substrate and the second substrate bonded together to form domes corresponding to a shape of the micro lenses in response to convexly swelling of a portion of the second substrate located on the cavities by volume expansion of air trapped in the cavities;
forming a mold by removing at least a portion of the first substrate such that openings formed on a back surface of the domes are exposed outside; and
forming the micro lens array by pouring a melted material for the micro lens array into the mold and curing.

11. The method for manufacturing the micro lens array according to claim 10, further comprising:
adjusting a height of the domes being formed, by adjusting the temperature applied to the first substrate and the second substrate bonded together.

12. The method for manufacturing the micro lens array according to claim 10, further comprising:
adjusting a height of the domes being formed, by adjusting a pressure around the first substrate and the second substrate bonded together.

13. The method for manufacturing the micro lens array according to claim 10, wherein the first substrate and the second substrate are bonded by anodic bonding.

14. The method for manufacturing the micro lens array according to claim 10, further comprising:
coating a nitride layer on a back surface of the first substrate along an edge part excluding as much as an area of the base substrate from a center,
wherein the forming of the mold by removing at least a portion of the first substrate is performed by a wet anisotropic etching process, and
the nitride layer is a mask layer that allows a nitride coating part to prevent the first substrate from being etched by the etching process.

15. The method for manufacturing the micro lens array according to claim 10, wherein the cavities are formed by deep reactive-ion etching (DRIE).

16. A micro lens array manufactured by the apparatus for manufacturing the micro lens array defined in claim 1.
